(19) United States
(12) Patent Application Publication
(10) Pub. No.: US 2003/0069808 A1
(43) Pub. Date: Apr. 10, 2003

(54) Incentive based purchasing system and method

(76) Inventor: Andrew John Cardno, Wellington (NZ)

Correspondence Address: David E. Bruhn, DORSEY & WHITNEY LLP, Suite 1500, 50 South Sixth Street, Minneapolis, MN, 55402-1498, US

(21) Appl. No.: 10/290,677

(22) Filed: Nov. 8, 2002

Related U.S. Application Data
(63) Continuation of application No. PCT/NZ01/00079, filed on May 9, 2001.

(30) Foreign Application Priority Data
May 9, 2000 (NZ) 504427

(51) Int. Cl. G06F 17/60

(52) U.S. Cl. 705/26

(57) ABSTRACT

The invention provides an incentive based purchasing system in which customers purchase items from a merchant at one or more checkout terminals, the system comprising a data memory in which is stored a transaction database comprising one or more transaction records, each transaction record comprising a customer identifier, a merchant identifier, and a transaction total; and a prize calculator arranged to calculate the percentage chance of a customer winning a prize when purchasing items from a merchant based on transaction records retrieved from the transaction database involving the customer and the merchant. The invention also provides a related associated method and computer program.

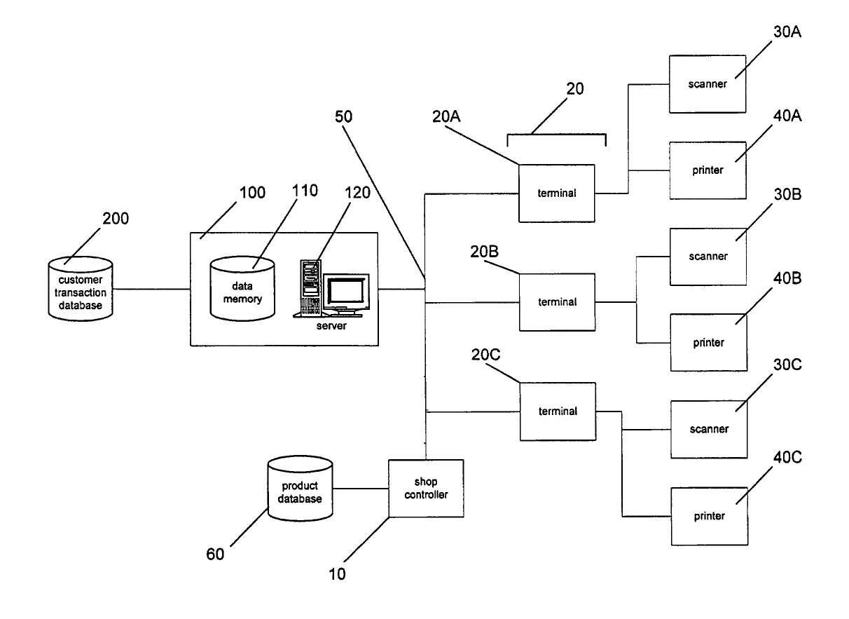

### FIELD OF INVENTION

The invention relates to an incentive based purchasing system and method.

### BACKGROUND TO INVENTION

There are many types of incentive based purchasing or sales promotion schemes in which purchasers are awarded points or coupons from each purchase and become entitled to a prize after a predetermined number of coupons have been accumulated. One example is a scheme in which customers accumulate points through purchases which can be redeemed for airfares and other services and goods.

Other schemes involve a merchant providing a purchaser with a label or other item with a particular item giving a purchaser a chance of winning a valuable prize. There is often a long delay between the date of purchase and the date on which the outcome of the lottery is known.

It would be particularly advantageous to provide a system in which purchasers have a chance of winning a prize with each purchase from a particular merchant based on prior purchases with that merchant.

### SUMMARY OF INVENTION

In broad terms in one form the invention comprises an incentive based purchasing system in which customers purchase items from a merchant at one or more checkout terminals, the system comprising a transaction database stored in computer memory, the transaction database comprising one or more transaction records, at least one transaction record including a customer identifier, a merchant identifier, and a transaction total; a maximum probability value maintained in computer memory; a retrieval component configured to calculate a purchase history by retrieving from the transaction database at least one transaction record involving the customer and the merchant and summing the transaction totals in each retrieved transaction record; and a prize calculator configured to calculate a probability of the customer winning a prize when purchasing items from the merchant based on the purchase history and the maximum probability value.

In another form in broad terms the invention comprises a method of providing an incentive for a customer to purchase items from a merchant at one or more checkout terminals, the method comprising the steps of maintaining in computer memory a transaction database comprising one or more transaction records, at least one transaction record including a customer identifier, a merchant identifier, and a transaction total; calculating a purchase history by retrieving from the transaction database at least one transaction record involving the customer and the merchant and summing the transaction totals in each retrieved transaction record; maintaining in computer memory a maximum probability value; and calculating a probability of the customer winning a prize when purchasing items from the merchant based on the purchase history and the maximum probability value.

### BRIEF DESCRIPTION OF THE FIGURE

Preferred forms of the incentive based purchasing system and method will now be described with reference to the accompanying FIGURE which shows a block diagram of a retail environment in which one form of the invention may be implemented.

### DETAILED DESCRIPTION OF PREFERRED FORMS

The FIGURE illustrates a retail environment in which the invention may be implemented. A typical retail premises includes a shop controller 10 and one or more checkout terminals 20, for example 20A, 20B and 20C. Each terminal 20 is interfaced to an optical scanner, for example 30A, 30B, and 30C, arranged to read barcode or uniform product code (UPC) data from items presented at the checkout terminal 20. Each terminal is also interfaced to a printing device, for example 40A, 40B and 40C, arranged to print out an inventory or list of the items purchased and the total cost.

The terminals 20 are usually interfaced to the shop controller 10 by a continuous data and control bus 50. The shop controller is preferably arranged to have access to databases such as a product database 60. The product database 60 typically comprises a series of records, each record representing a product or item sold by the shop. Each product record usually comprises a product identifier, a product price, and other data specific to the product. The product record could include a barcode or uniform product code (UPC) identifier, or alternatively each product record could be identified by the barcode or UPC.

As each customer presents products or items for purchase at a checkout terminal 20, an operator scans each item with the scanner 30 for a barcode or UPC printed on the item packaging which uniquely identifies the product or item. The scanned barcode is transmitted to the shop controller 10 over the data bus 50, then transmitted to the product database 60. The product record corresponding to the barcode is retrieved from the product database 60 and transmitted to the shop controller 10. The shop controller 10 transmits the product price to the terminal 20 where it is added to a cumulative total of product purchases for a particular customer transaction. Once all products have been scanned, a list is made of these products or items and output on printer 40, together with a total. The customer then makes payment for the transaction by cash, credit card, debit card, cheque, electronic funds transfer, or in any other suitable manner.

As shown in the FIGURE, a workstation 100 in accordance with the invention is interfaced to the data bus 50. The workstation 100 preferably further comprises a data memory 110 and a processor 120. The workstation has installed on it appropriate operating and application software and is programmed to perform various functions set out below in accordance with the invention. It will be appreciated that the workstation 100 could alternatively comprise a data memory and processor installed and operating in a terminal 20.

The workstation 100 is also interfaced to a customer transaction database 200. The customer transaction database 200 preferably comprises a series of transaction records. Each transaction record includes at least a customer identifier, a merchant identifier, and a transaction value of the transaction.

The merchant may, for example, issue an incentive-supported customer loyalty card which is then used by the customer during a transaction at a terminal 20. The loyalty card preferably has stored on it a customer identifier and may have stored other data, for example residential address and family size of the customer. In a point of sale system, the customer could produce the loyalty card which is then swiped through a card reader or processed with scanner 30 when a transaction is made.

The merchant identifier could be used to identify a particular merchant, and where a merchant operates from more than one geographic location, the merchant identifier, or some other identifier included in the record, may identify the geographic location in which the transaction occurs.

Each customer transaction record could also include other data, for example the date and/or time at which the transaction between the customer and the merchant took place.

In one form of the invention, whenever a customer purchases or items from a merchant at terminal 20, the customer has a chance to win a prize, with the chance of winning increasing with each item purchased as the total in the transaction increases. The workstation 100 could include a prize calculator arranged to calculate the chance of winning a prize as a percentage for each item purchased. In this way, a merchant may provide an incentive for a customer to purchase items.

Where the workstation 100 is programmed to perform specific functions, the prize calculator could comprise a computer program or other computer implemented set of instructions for calculating a percentage. Alternatively, the prize calculator could be implemented in hardware form as an integrated circuit.

The prize calculator could calculate a percentage based on the following equation:

p(H)=(2Pₘ/Π)arctan(H/Hₒ) (1)

In the above equation, H is the history of total purchases by a particular customer. This history of total purchases could be obtained by retrieving from the customer database 200 every transaction with a particular merchant by that customer and summing the total value for each transaction to produce the value of H. Pₘ is a maximum probability value which could be defined by a merchant, and H₀ is a typical history value.

By way of example, if the maximum probably Pₘ is 50% and H₀=$1,000, the following table sets out example probabilities of winning a prize given a particular history total:

| p(H) | Probability |
|---|---|
| $1 | 0.03 |
| $100 | 3.7 |
| $500 | 14.8 |
| $1,000 | 25 |
| $5,000 | 44 |

As will be apparent from the above table, the chance of winning a prize increases proportionately as the history of purchases increases. At first, the increases are linear, and as the transaction increases, the rate of increase slows to a maximum of 50%, being the merchant defined maximum probability.

The prize calculator computes the probability of winning a prize and transmits this probability to the terminal 20 for display on a terminal display unit and/or production of a printed record on printer 40. The prize calculator also generates a random number and compares this number to the probability to determine whether or not the customer has won a prize. Data representing the success or failure of the customer is also transmitted to the terminal 20 for display and/or production of a printed record.

In a further preferred form, the prize calculator also stores data relating to products or items which are linked, for example products which have something in common or are commonly bought together. The customer preferably increases the chance of winning by buying items that are linked. For example, when a customer buys a bottle of milk, the customer knows that the milk is linked to a loaf of bread and a newspaper, and that if the customer buys a linked item, the customer has a better chance of winning something when the customer presents the products or items at a terminal 20.

The product database 60 or other database could store a series of categories, each category having two or more types of goods or services as members. In one form, the invention could be programmed so that where two or more items in a transaction belong to the same category, the probability of winning a prize P is increased to:

p(H)=(2Pₘ/Π)arctan(H/Ho)+Pₗ (2)

In the above equation, Pₗ is a link probability bonus. In the example above, if Pₗ=25%, the probability values could be increased to those shown in the following table:

| p(H) | Probability | Probability Bonus |
|---|---|---|
| $1 | 0.03 | 25.03 |
| $100 | 3.7 | 28.7 |
| $500 | 14.8 | 39.8 |
| $1,000 | 25 | 50 |

as they occur, increasing the probability of winning a prize in subsequent transactions with the same merchant.

The invention could also comprise a jackpot and/or bonus scheme, in which the customer has a chance to win the jackpot whenever a transaction is processed.

One form of prize could include bonus vouchers for a certain dollar amount to be redeemed at the merchant premises, or vouchers for items or services which could be redeemed when buying another item or service from the same merchant. The value of the vouchers could be a fixed amount, or could be dependent upon the volume and value of purchases made by the customer. The customer could also be given a credit on a loyalty card instead of being sent vouchers, which would be redeemed when the card was produced.

The foregoing describes the invention including preferred forms thereof. Alterations and modifications as will be obvious to those skilled in the art are intended to be incorporated within the scope hereof, as defined by the accompanying claims.

1. An incentive based purchasing system in which customers purchase items from a merchant at one or more checkout terminals, the system comprising:
a transaction database stored in computer memory, the transaction database comprising one or more transaction records, at least one transaction record including a customer identifier, a merchant identifier, and a transaction total;
a maximum probability value maintained in computer memory;
a retrieval component configured to calculate a purchase history by retrieving from the transaction database at least one transaction record involving the customer and the merchant and summing the transaction totals in each retrieved transaction record; and
a prize calculator configured to calculate a probability of the customer winning a prize when purchasing items from the merchant based on the purchase history and the maximum probability value.

2. An incentive based purchasing system as claimed in claim 1 wherein the calculated probability increases as the purchase history increases, the rate of increase of the probability decreasing as the calculated probability approaches the maximum probability value.

3. An incentive based purchasing system as claimed in claim 1 or claim 2 further comprising a link probability bonus maintained in computer memory, the prize calculator configured to add the link probability bonus to the calculated probability.

4. An incentive based purchasing system as claimed in claim 3 further comprising one or more categories maintained in computer memory having as members two or more types of items, the prize calculator configured to add the link probability bonus to the calculated probability when the customer purchases two or more items from the same category from the merchant.

5. A method of providing an incentive for a customer to purchase items from a merchant at one or more checkout terminals, the method comprising the steps of:
maintaining in computer memory a transaction database comprising one or more transaction records, at least one transaction record including a customer identifier, a merchant identifier, and a transaction total;
calculating a purchase history by retrieving from the transaction database at least one transaction record involving the customer and the merchant and summing the transaction totals in each retrieved transaction record;
maintaining in computer memory a maximum probability value; and
calculating a probability of the customer winning a prize when purchasing items from the merchant based on the purchase history and the maximum probability value.

6. A method as claimed in claim 5 wherein the calculated probability increases as the purchase history increases, the rate of increase of the probability decreasing as the calculated probability approaches the maximum probability value.

7. A method as claimed in claim 5 or claim 6 further comprising the steps of:
maintaining in computer memory a link probability bonus; and
adding the link probability bonus to the calculated probability.

8. A method as claimed in claim 7 further comprising the steps of:
maintaining in computer memory one or more categories having as members two or more types of items; and
adding the link probability bonus to the calculated probability when the customer purchases two or more items from the same category from the merchant.
